(19) United States
(12) Patent Application Publication
(10) Pub. No.: US 2023/0401787 A1
(43) Pub. Date: Dec. 14, 2023

(54) INFORMATION PROCESSING APPARATUS GENERATING THREE-DIMENSIONAL SHAPE DATA, CONTROL METHOD, AND STORAGE MEDIUM

(71) Applicant: CANON KABUSHIKI KAISHA, Tokyo (JP)

(72) Inventor: CHIAKI KANEKO, Kanagawa (JP)

(21) Appl. No.: 18/329,454

(22) Filed: Jun. 5, 2023

(30) Foreign Application Priority Data
Jun. 9, 2022 (JP) 2022-093795

(51) Int. Cl. G06T 17/00; G06T 7/20; G06T 7/60; G06V 10/25

(52) U.S. Cl. CPC G06T 17/00; G06T 7/20; G06T 7/60; G06V 10/25; G06T 2207/30196

(57) ABSTRACT

An information processing apparatus includes one or more memories storing instructions, and one or more processors, wherein the one or more processors execute the instructions to acquire region information representing a spatial region in a three-dimensional space, acquire attribute information regarding an object, and generate a plurality of pieces of object data representing a shape and an arrangement of the object based on the acquired region information and the acquired attribute information, wherein, in the plurality of pieces of object data, a union of ratios of a shape model corresponding to the object is a predetermined ratio or more in a region corresponding to the spatial region.

### BACKGROUND

### Field of the Disclosure

The present disclosure relates to a technique for generating three-dimensional shape data.

### Description of the Related Art

Conventionally, a shape estimation technique is known for estimating a three-dimensional shape of an object based on a two-dimensional image obtained by capturing the object. As a technique for evaluating accuracy of shape estimation, Japanese Patent Application Laid-Open No. 2013-160602 discusses an evaluation technique using a three-dimensional shape model of an object.

The accuracy of shape estimation tends to depend on a positional relationship between an image capturing apparatus that configures an image capturing system and an object. For example, in a case where a shape of an object such as a person is estimated using an image capturing system including a plurality of digital cameras in different positions and orientations, the number of the digital cameras that capture the object within an angle of view changes depending on a position of the object. The accuracy tends to increase as the number of the digital cameras that capture the object increases, and the accuracy tends to decrease as the number decreases. In a case where the position of the object changes in the above-described image capturing system, it is convenient to be able to evaluate the accuracy of shape estimation of the object according to the position of the object. As an evaluation method, there is a method of evaluation using a data set obtained by arranging a three-dimensional shape model of an object at various positions. However, there is an issue that a large amount of effort is required to manually create a large number of data sets.

### SUMMARY

According to an aspect of the present disclosure, an information processing apparatus includes one or more memories storing instructions, and one or more processors, wherein the one or more processors execute the instructions to acquire region information representing a spatial region in a three-dimensional space, acquire attribute information regarding an object, and generate a plurality of pieces of object data representing a shape and an arrangement of the object based on the acquired region information and the acquired attribute information, wherein, in the plurality of pieces of object data, a union of ratios of a shape model corresponding to the object is a predetermined ratio or more in a region corresponding to the spatial region.

Further features of various embodiments will become apparent from the following description of exemplary embodiments with reference to the attached drawings.

### BRIEF DESCRIPTION OF THE DRAWINGS

FIG. 1 is a block diagram illustrating a hardware configuration of an information processing apparatus.

FIG. 2 is a block diagram illustrating a logical configuration of an information processing apparatus according to a first exemplary embodiment.

FIG. 3 is a schematic diagram illustrating a voxel and a capturing spatial region.

FIGS. 4A and 4B are schematic diagrams illustrating examples of objects.

FIG. 5 is a flowchart illustrating an overall flow of processing executed by the information processing apparatus according to the first exemplary embodiment.

FIG. 6 illustrates an example of a graphical user interface (GUI) according to the first exemplary embodiment.

FIG. 7 is a flowchart illustrating a flow of object data generation processing according to the first exemplary embodiment.

FIGS. 8A and 8B are schematic diagrams illustrating arrangements of an object.

FIGS. 9A to 9C are schematic diagrams illustrating examples of combinations of arrangements.

FIGS. 10A and 10B illustrates examples of other GUIs according to the first exemplary embodiment.

FIG. 11 is a block diagram illustrating a logical configuration of an information processing apparatus according to a second exemplary embodiment.

FIG. 12 is a flowchart illustrating an overall flow of processing executed by the information processing apparatus according to the second exemplary embodiment.

FIG. 13 illustrates an example of a GUI according to the second exemplary embodiment.

FIG. 14 illustrates an example of a GUI according to a third exemplary embodiment.

FIG. 15 is a flowchart illustrating a flow of object data generation processing according to the third exemplary embodiment.

FIG. 16 is a schematic diagram illustrating an example of object data according to the third exemplary embodiment.

FIG. 17 is a flowchart illustrating an overall flow of processing executed by an information processing apparatus according to a fourth exemplary embodiment.

FIGS. 18A to 18C are schematic diagrams illustrating examples of rearrangements of object data.

### DESCRIPTION OF THE EMBODIMENTS

Exemplary embodiments of the present disclosure will be described below with reference to the attached drawings. It is noted that the following exemplary embodiments are not meant to limit every embodiment, and not all combinations of features described in the exemplary embodiments are essential for solving means of the present disclosure. The same configuration will be described with the same reference numeral.

### <Hardware Configuration>

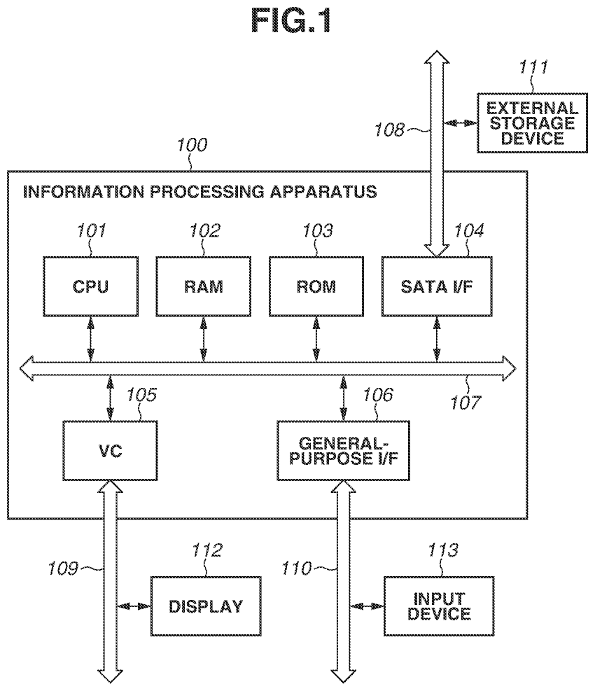

FIG. 1 illustrates an example of a hardware configuration of an information processing apparatus according to a first exemplary embodiment.

In FIG. 1, an information processing apparatus 100 includes a central processing unit (CPU) 101, a random access memory (RAM) 102, a read-only memory (ROM) 103, a Serial Advanced Technology Attachment (SATA) interface (I/F) 104, a video card (VC) 105, and a general-purpose I/F 106.

The CPU 101 is a processor for executing an operating system (OS) and various programs stored in the ROM 103, an external storage device 111, and the like using the RAM 102 as a work memory. The OS and the various programs may be stored in an internal storage device. The CPU 101 also controls each configuration via a system bus 107. Processing according to flowcharts described below is executed by the CPU 101 loading program code stored in the ROM 103, the external storage device 111, and the like into the RAM 102.

The SATA I/F 104 is connected to the external storage device 111 via a serial bus 108. The external storage device 111 is a hard disk drive (HDD) or a solid state drive (SSD). The VC 105 is connected to a display 112 via a serial bus 109. The general-purpose I/F 106 is connected to an input device 113, such as a mouse and a keyboard, via a serial bus 110.

The CPU 101 displays a graphical user interface (GUI) provided by a program on the display 112 and receives input information representing a user instruction acquired via the input device 113. The information processing apparatus 100 is realized, for example, by a desktop personal computer (PC). Alternatively, the information processing apparatus 100 may be realized by a laptop PC or a tablet PC integrated with the display 112. The external storage device 111 is also realized by a medium (a recording medium) and an external storage drive for accessing the medium. A flexible disk (FD), a compact disk (CD)-ROM, a digital versatile disk (DVD), a universal serial bus (USB) memory, a magneto-optical (MO) disk, a flash memory, and the like can be used as the media.

### <Logical Configuration>

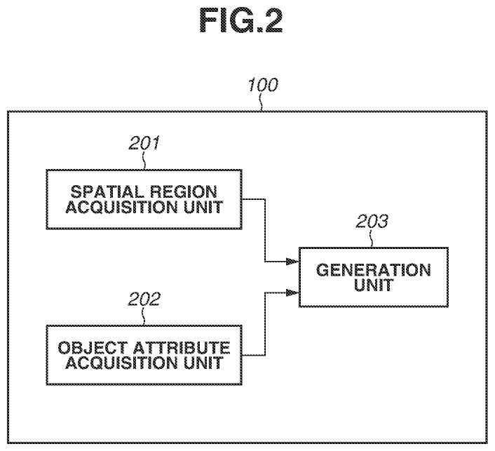

FIG. 2 is a block diagram illustrating a logical configuration of the information processing apparatus 100 according to the present exemplary embodiment.

The information processing apparatus 100 functions as the logical configuration illustrated in FIG. 2 by the CPU 101 executing a program stored in the ROM 103 using the RAM 102 as the work memory. All of the processing described below does not necessarily have to be executed by the CPU 101, and the information processing apparatus 100 may be configured so that a part or all of the processing is performed by one or more processing circuits other than the CPU 101.

The information processing apparatus 100 includes a spatial region acquisition unit 201, an object attribute acquisition unit 202, and a generation unit 203.

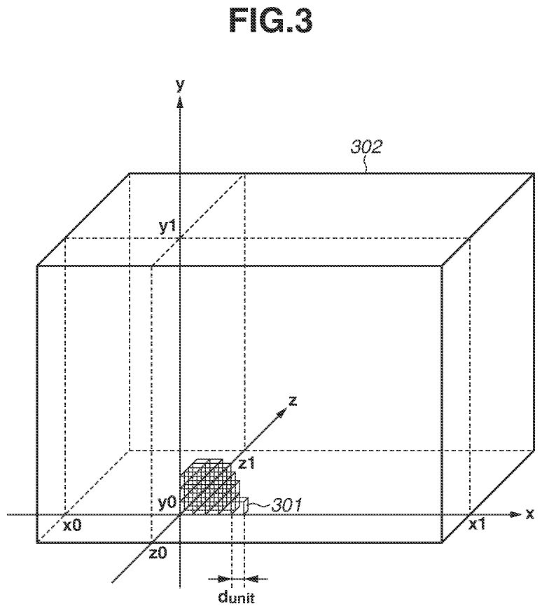

The spatial region acquisition unit 201 acquires a size of a voxel, which is a unit volume element that forms a three-dimensional space, and a range of a capturing spatial region as region information based on a user instruction input via the input device 113. A capturing space region is a region in which a target (that is, an object) of which a shape is to be estimated can exist. FIG. 3 illustrates an example of a voxel and a capturing spatial region. In the example in FIG. 3, a voxel 301 is a cube with a side length of dᵤₙᵢₜ. Further, a capturing spatial region 302 is a region in a range of x0≤x≤x1, y0≤y≤y1, and z0≤z≤z1 in a xyz space. The acquired region information is transmitted to the generation unit 203.

The object attribute acquisition unit 202 acquires attribute information about an object based on a user instruction input via the input device 113. Attribute information is information indicating the number and shape characteristics of objects. According to the present exemplary embodiment, a person is an assumed object, and the number, body height, and body width of the objects are acquired as the attribute information. Instead of (or in addition to) the body height and the body width, the attribute information may include information that indirectly indicates the characteristics of the shape of the object, such as gender and age. The assumed object may be an object other than a person, and in this case, the number of objects and the sizes of the objects may be the attribute information. The acquired attribute information is transmitted to the generation unit 203.

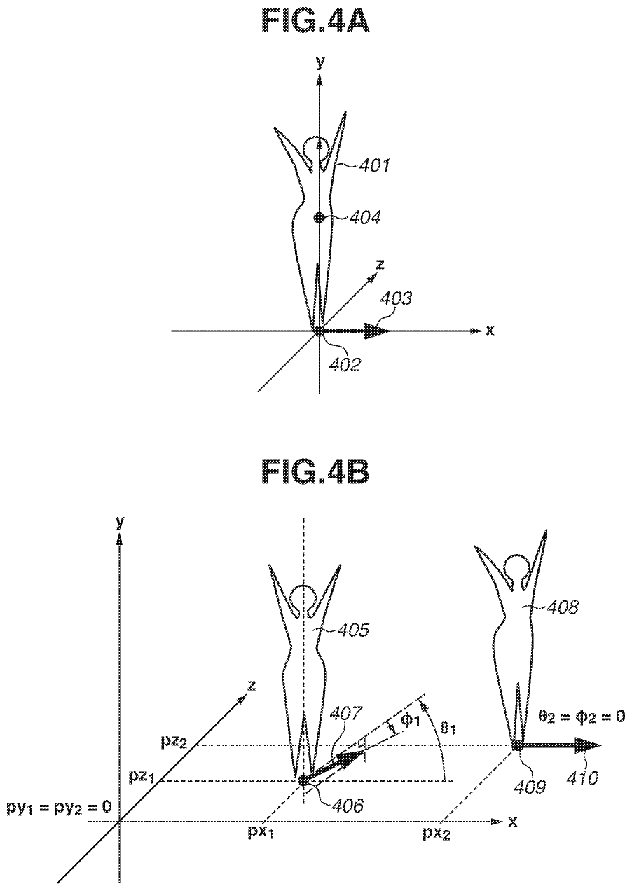

The generation unit 203 generates a plurality of patterns of object data representing the shape and arrangement of the object in a three-dimensional space based on the region information and the attribute information. The object data according to the present exemplary embodiment includes a shape model representing a shape of an individual object person using a polygon mesh, and position coordinates and an orientation (a rotation angle) of each object person. The shape model is configured with a list of three-dimensional coordinates of vertices that make up the polygon mesh. FIGS. 4A and 4B illustrate examples of shape models and object data.

FIG. 4A illustrates an object shape indicated by a shape model. In FIG. 4A, a shape model 401 is a polygon mesh representing a surface shape of the object. A point 402 and a direction 403 are respectively a reference point and a front direction of the shape model 401. In the example in FIG. 4A, the reference point 402 is a foot of a perpendicular line from the center of gravity 404 of the shape model 401 to an xz plane, and the front direction 403 is an x-axis direction.

FIG. 4B illustrates the objects arranged in a three-dimensional space indicated by the object data. In the example in FIG. 4B, two shape models 405 and 408 are arranged. A point 406 and a direction 407 respectively represent a reference point and an orientation of the shape model 405. A point 409 and a direction 410 respectively represent a reference point and an orientation of the shape model 408. In FIG. 4B, coordinates (px₁, py₁, pz₁) and coordinates (px₂, py₂, pz₂) are respectively position coordinates of the shape models 405 and 408. Rotation angles θ₁ and φ₁ represent the orientation of the shape model 405. Rotation angles θ₂ and φ₂ represent the orientation of the shape model 408.

The shape model may include uv coordinates (that is, texture coordinates) corresponding to the xyz coordinates of the vertices that make up the polygon mesh, and color information for each of the vertices. Generation of the object data is described in detail below. The plurality of generated patterns of object data is output to and stored in the external storage device 111 and the like as an object data set.

### <Processing to be Executed>

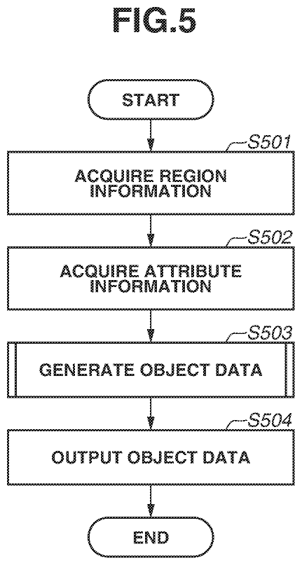

FIG. 5 is a flowchart illustrating an overall flow of processing executed by the information processing apparatus 100.

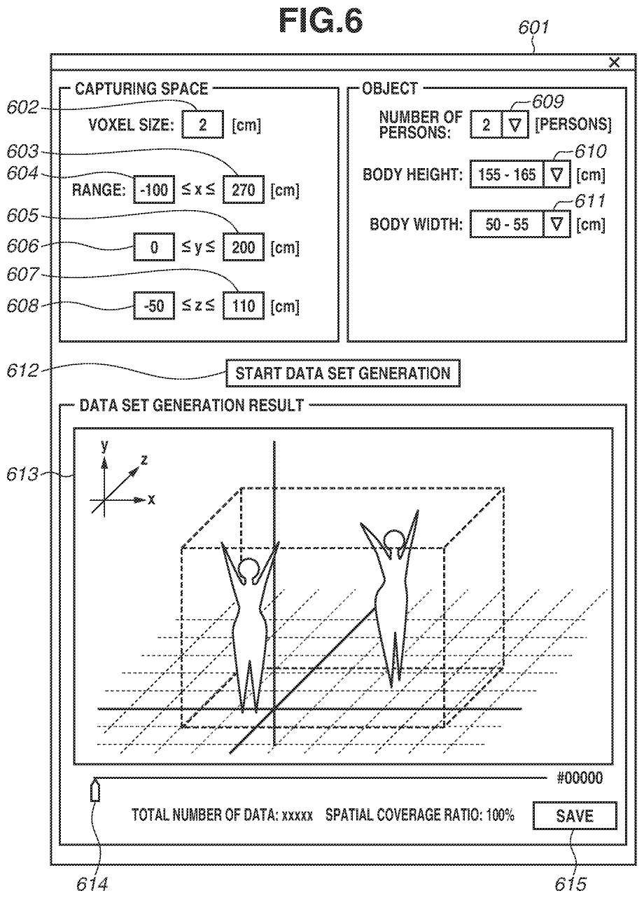

In step S501, the spatial region acquisition unit 201 acquires the size of the voxel and the range of the capturing spatial region based on a user instruction. In step S502, the object attribute acquisition unit 202 acquires the number of persons, the body heights, and the body widths of the objects based on the user instruction. The object attribute acquisition unit 202 receives the user instruction via, for example, a GUI 601 displayed on the display 112 as illustrated in FIG. 6.

In FIG. 6, a setting column 602 is a column for inputting a length of one side of the voxel as the size of the voxel. Setting columns 603, 604, 605, 606, 607, and 608 are respective columns for inputting a start point x0 and an end point x1 in the x-axis direction, a start point y0 and an end point y1 in a y-axis direction, and a start point z0 and an end point z1 in a z-axis direction of the capturing spatial region. Object attribute setting lists 609, 610, and 611 are respective pull-down lists for selecting the number of persons, the body height, and the body width of the assumed objects. A button 612 is a button for a user to issue an instruction to execute object data generation processing, which is described below. A display area 613 is an area for displaying an image regarding the generated object data. A slider 614 is a slider for designating an identification number of the object data to be displayed in the display area 613. A button 615 is a button for the user to issue an instruction to store the generated object data. If the user presses the button 612, the processing in steps S501 and S502 is executed.

The information acquired in steps S501 and S502 corresponds to the region information and the attribute information of the object.

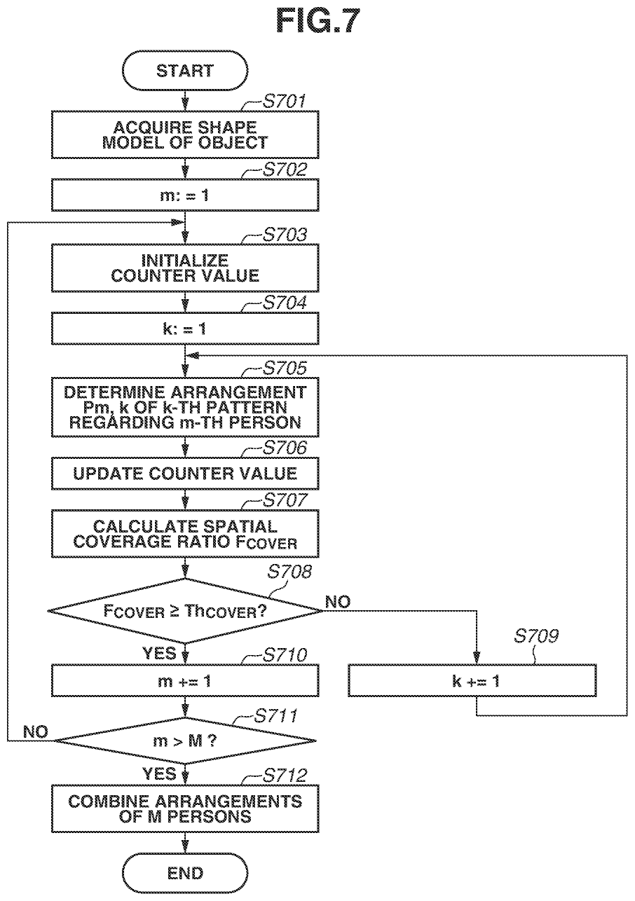

In step S503, the generation unit 203 generates a plurality of pieces of object data based on the region information and the attribute information of the object acquired in steps S501 and S502. The generation unit 203 continues to generate the object data by changing the arrangement of the object until a union of ratios of the objects in the capturing spatial region (hereinbelow referred to as a spatial coverage ratio) reaches a predetermined ratio or more. The processing in step S503 is described in detail below with reference to FIG. 7 including an example of the spatial coverage ratio. According to the present exemplary embodiment, a ratio of a shape surface of the object in the capturing spatial region is calculated in units of voxels and used as the spatial coverage ratio. Further, according to the present exemplary embodiment, a predetermined ratio is described as a target spatial coverage ratio Th_{COVER}. The target spatial coverage ratio Th_{COVER} may be set in advance, or may be set separately based on a user instruction.

In step S504, the generation unit 203 stores the plurality of pieces of object data generated in step S503 as a data set (an object data set) in the external storage device 111 or the like, and terminates the processing. As illustrated in the display area 613 in FIG. 6, a rendering image based on the generated object data may be displayed on the GUI 601. Known computer graphics technology can be used to generate the rendering image. In the example in FIG. 6, a rendering image based on the object data of the number designated by the slider 614 is displayed.

In FIG. 6, the objects indicated by the object data designated by the slider 614 are two persons arranged with a distance between them. A user can change an image of the object data displayed in the display area 613 by operating the slider 614. In addition, the user can visually confirm what kind of object data is generated by referring to the image of the object data displayed in the display area 613,

### <Detail of Object Data Generation Processing in Step S503>

Details of the object data generation processing performed by the generation unit 203 are described with reference to a flowchart illustrated in FIG. 7. In the following description, the number of persons of objects acquired in step S502 is assumed to be M (M is an integer greater than or equal to one).

In step S701, the generation unit 203 acquires a shape model of the object based on the body height and the body width of the object acquired in step S502. For example, the generation unit 203 acquires the shape model corresponding to the body height and the body width acquired in step S502 from a database in which various shape models generated for objects are associated with attributes. Alternatively, the generation unit 203 may acquire the shape model of the object by transforming the shape model acquired from the external storage device 111 based on the body height and the body width acquired in step S502. According to the present exemplary embodiment, the generation unit 203 acquires one common shape model for the objects (persons) of M persons.

In step S702, the generation unit 203 sets one to an index m that indicates one of the objects (persons) of M persons.

In step S703, the generation unit 203 initializes each value of a counter f_{COUNT}(ix, iy, iz) corresponding to each voxel v(ix, iy, iz) forming the capturing spatial region to zero. Here, indices ix, iy, and iz indicate the voxel position.

In step S704, the generation unit 203 sets 1 to an index k indicating what number of arrangement is regarding the object with the index m.

In step S705, the generation unit 203 selects the position coordinates (x_{P(m, k)}, y_{P(m, k)}, z_{P(m, k)}) of one point from within the capturing spatial region and arranges the shape model acquired in step S701 at the selected position. The position coordinates (x_{P(m, k)}, y_{P(m, k)}, z_{P(m, k)}) and the orientation (that is, a rotation angle about the reference point) of the shape model may be determined randomly or based on an arbitrary rule set in advance. For example, in consideration of a general movement of a person, the coordinate y_{P(m, k)} in the y-axis direction (vertical direction) may be fixed, and a change in the orientation may be limited only to a rotation about the y-axis. Hereinbelow, the position coordinates and the orientation of the shape model are collectively referred to as “arrangement”, and the k-th arrangement regarding the shape model of the object with the index m is expressed as P(m, k).

In step S706, the generation unit 203 determines the voxel that intersects with a surface of the shape model arranged in step S705 among the voxels forming the capturing spatial region.

The generation unit 203 adds +1 to a value of the counter corresponding to the voxel that intersects with the surface of the shape model arranged in step S705.

In step S707, the generation unit 203 calculates a spatial coverage ratio F_{COVER} based on the counter value. According to the present exemplary embodiment, the spatial coverage ratio F_{COVER} is given by the following equation.

F_{COVER}=VNUM₊/VNUM_{ALL} Equation (1)

In Equation (1), VNUM₊ is the number of the voxels of which the counter value is one or more, and VNUM_{ALL} is the total number of the voxels forming the capturing spatial region. The value of the counter f_{COUNT}(ix, iy, iz) is one or more in a case where the voxel v(ix, iy, iz) is the surface of the shape model in any of the arrangements P(m, 1), P(m, 2), . . . , and P(m, k) of the shape model of the object with the index m. Thus, the spatial coverage ratio F_{COVER} given by Equation (1) represents the union of the ratios of the voxels that are the object surfaces in one or more of the k arrangements in the capturing spatial region.

In step S708, the generation unit 203 determines whether the spatial coverage ratio F_{COVER} acquired in step S707 is the target spatial coverage ratio Th_{COVER} or more. In a case where the spatial coverage ratio F_{COVER} is the target spatial coverage ratio Th_{COVER} or more, it can be considered that the arrangements of the shape model of the object with the index m based on the k arrangements determined by the above-described processing sufficiently cover the capturing spatial region. Thus, in a case where the spatial coverage ratio F_{COVER} is the target spatial coverage ratio Th_{COVER} or more (YES in step S708), the processing in step S710 is executed. In a case where the spatial coverage ratio F_{COVER} is less than the target spatial coverage ratio Th_{COVER} (NO in step S708), then in step S709, the generation unit 203 adds +1 to the index k and returns the processing to step S705.

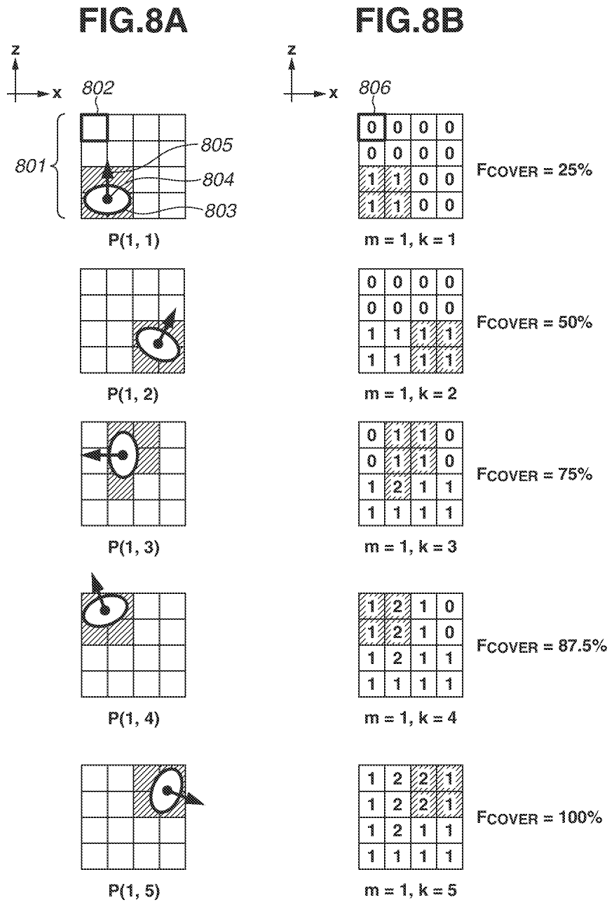

Examples of the arrangements, the counter values, and the spatial coverage ratios determined by the processing in steps S705 to S707 are described with reference to FIGS. 8A and 8B. In FIGS. 8A and 8B, a capturing spatial region 801 is described as a spatial region formed by the voxels arranged in a two-dimensional plane to simplify the description. FIG. 8A illustrates examples of the arrangement P(m, k) (m=1, k=1, 2, . . . , 5) determined in step S705. In FIG. 8A, a rectangle 802 is the voxel, a shape 803 is a shape indicated by the shape model, a point 804 is a reference point of the shape model, and a direction 805 is the front direction of the shape model. A shaded area indicates the voxel that intersects with the surface of the arranged shape model. FIG. 8B illustrates the counter values updated in step S706 and the spatial coverage ratios F_{COVER} calculated in step S707 in a case where the arrangements are determined as in FIG. 8A. In FIG. 8B, a number in a rectangle 806 corresponds to the counter corresponding to the voxel in the rectangle 802, a shaded area corresponds to the voxel in the shaded area in FIG. 8A (that is, the voxel intersects with the surface of the arranged shape model). In a case where the target spatial coverage ratio Th_{COVER} is, for example, 100%, the spatial coverage ratio F_{COVER} becomes the target spatial coverage ratio Th_{COVER} or more for the first time when k=5. In this case, the processing in step S710 is executed in response to the spatial coverage ratio F_{COVER} reaching 100%.

In step S710, the generation unit 203 adds +1 to the index m of the object person. In step S711, the generation unit 203 determines whether the index m is greater than M. In a case where the index m is greater than M (YES in step S711), the processing in step S712 is executed. In a case where the index m is M or less (NO in step S711), the processing returns to step S703.

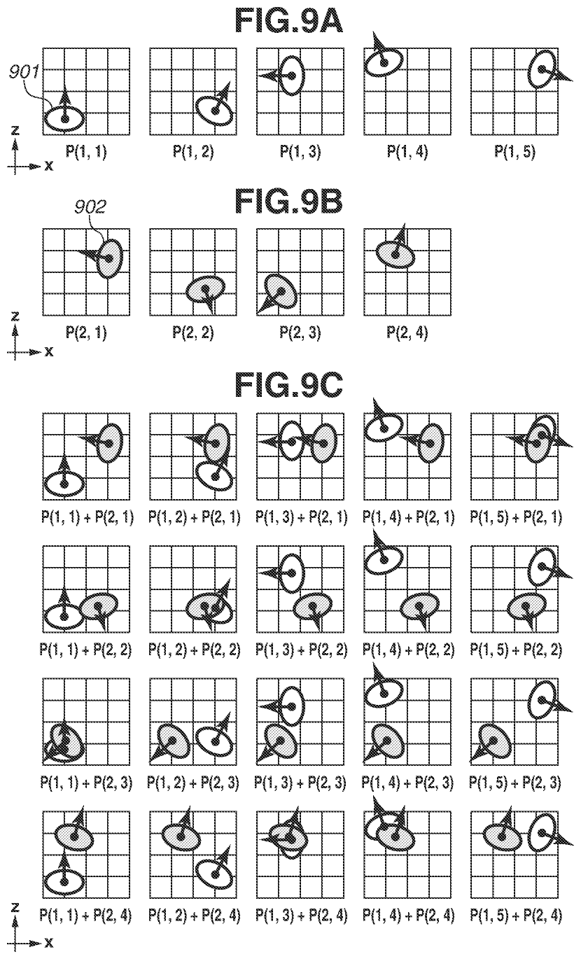

In step S712, the generation unit 203 combines the arrangements determined in steps S702 to S711 to generate object data including the objects (persons) of M persons, and terminates the object data generation processing. Specifically, the generation unit 203 generates and stores object data in which one arrangement at each index m (=1, 2, . . . , M) is combined with each other. According to the present exemplary embodiment, the generation unit 203 generates the object data described above for all combinations of the arrangements. FIGS. 9A to 9C illustrate examples in a case of M=2.

FIG. 9A illustrates examples of arrangements P(1, k₁) (k₁=1, 2, . . . , 5) of an object 901 with the index m of 1. FIG. 9B illustrates examples of arrangements P(2, k₂) (k₂=1, 2, 3, 4) of an object 902 with the index m of 2. FIG. 9C illustrates examples of all combinations of the arrangements P(1, k₁) and P(2, k₂). The spatial coverage ratios F_{COVER} corresponding to the arrangements P(1, k₁) and P(2, k₂) are each determined to be the target spatial coverage ratio Th_{COVER} or more by the processing in steps S702 to S711 described above. Thus, by combining the arrangements P(1, k₁) and P(2, k₂), it is possible to comprehensively generate an object data set including various patterns of positional relationships between two persons. The object data in which the shape models of the objects are arranged to overlap may not be generated considering that it is unrealistic for a plurality of persons to overlap. For example, combinations of P(1, 5)+P(2, 1), P(1, 2)+P(2, 2), P(1, 1)+P(2, 3), and P(1, 3)+P(2, 4) in FIG. 9C need not be generated as object data.

The above-described processing control is performed, and thus it is possible to easily acquire a data set of object data for evaluating accuracy of shape estimation regarding the image capturing system.

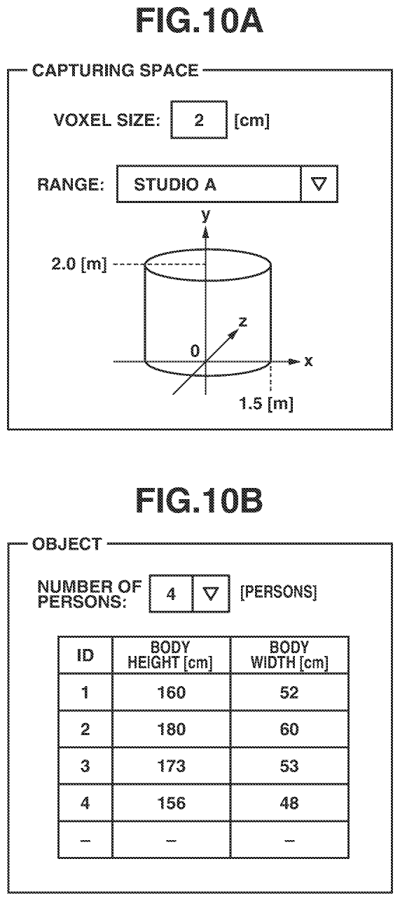

According to the present exemplary embodiment, the example is described in which a range input by a user via the GUI illustrated in FIG. 6 is acquired as the range of the capturing spatial region, but a method for acquiring the range of the capturing spatial region is not limited to this example. For example, a range corresponding to a name input by a user via the GUI may be acquired by referring to a lookup table (LUT) in which a spatial range of a captured space is associated with a name corresponding to the captured space. FIG. 10A illustrates an example of a GUI in this case. In this case, the LUT is generated in advance and stored in the external storage device 111 or the like.

In a case where the object includes a plurality of persons, the body height and the body width, which are the attribute information, may be specified individually as illustrated in FIG. 10B. In this case, the generation unit 203 acquires the shape model for each object in step S701.

The example is described in which the value calculated according to Equation (1) based on the number of the voxels is used as the spatial coverage ratio, but the spatial coverage ratio may be calculated using another method as long as it represents the ratio of the object occupying the capturing spatial region. For example, a ratio of a union of volumes of the shape model of the object in a volume of the capturing spatial region may be used as the spatial coverage ratio. In this case, in step S706, the generation unit 203 may calculate the voxel included inside the shape model in addition to the voxel that intersects with the surface of the shape model, and increment the value of the counter corresponding to them by one.

According to the first exemplary embodiment, the method for generating a data set of object data (an object data set) is described. According to a second exemplary embodiment, an example of evaluating estimation accuracy of shape estimation regarding an image capturing system using a generated data set is described.

A hardware configuration of an information processing apparatus 100 according to the present exemplary embodiment is similar to that according to the first exemplary embodiment, so that the description thereof is omitted. Differences between the present exemplary embodiment and the first exemplary embodiment are mainly described below. Configurations that are the same as those according to the first exemplary embodiment are described with the same reference numerals.

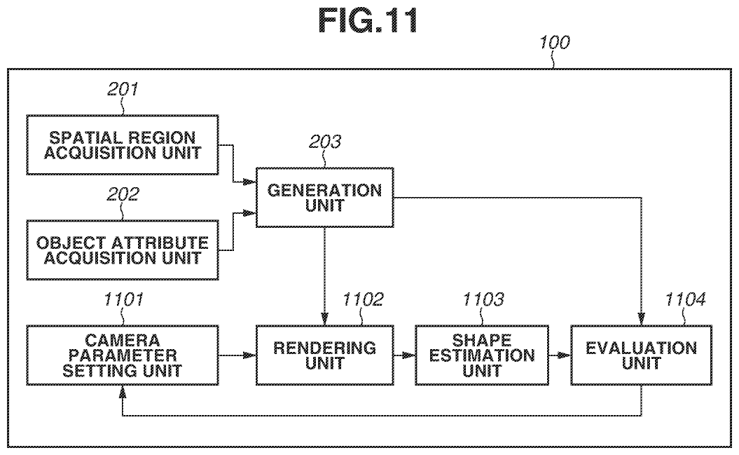

FIG. 11 is a block diagram illustrating a logical configuration of the information processing apparatus 100 according to the present exemplary embodiment. The information processing apparatus 100 includes a spatial region acquisition unit 201, an object attribute acquisition unit 202, a generation unit 203, a camera parameter setting unit 1101, a rendering unit 1102, a shape estimation unit 1103, and an evaluation unit 1104. The spatial region acquisition unit 201, the object attribute acquisition unit 202, and the generation unit 203 are the same as those according to the first exemplary embodiment, so that the descriptions thereof are omitted. However, according to the present exemplary embodiment, an object data set including a plurality of patterns of object data generated by the generation unit 203 is transmitted to the rendering unit 1102 and the evaluation unit 1104.

The camera parameter setting unit 1101 sets camera parameters of the image capturing system as an evaluation target based on a user instruction input via the input device 113. The camera parameters according to the present exemplary embodiment include an internal parameter, an external parameter, and a distortion parameter of each digital camera included in the image capturing system. The internal parameter is a parameter representing a position of a principal point of the digital camera and a focal length of a lens. The external parameter is a parameter representing a position and an orientation of the digital camera. The distortion parameter is a parameter representing distortion of the lens of the digital camera. The set camera parameters are transmitted to the rendering unit 1102.

The rendering unit 1102 generates a simulation image in a case where the image capturing system captures an image of an object based on the camera parameters and the object data set. According to the present exemplary embodiment, the generated simulation image is also referred to as an imaging simulation image. Details are described below. The generated imaging simulation image is transmitted to the shape estimation unit 1103.

The shape estimation unit 1103 applies a predetermined shape estimation algorithm to the imaging simulation image to estimate a shape of the object. The predetermined shape estimation algorithm may be a method for estimating a three-dimensional shape of an object based on a two-dimensional image obtained by capturing the object, such as a known visual hull (shape-from-silhouette) method or a method using stereo matching. Hereinbelow, data representing a three-dimensional shape acquired as a result of estimation is referred to as estimated shape data. The estimated shape data acquired is transmitted to the evaluation unit 1104.

The evaluation unit 1104 evaluates estimation accuracy of shape estimation (shape estimation accuracy) based on the object data and the estimated shape data and displays the result on the GUI. Details are described below.

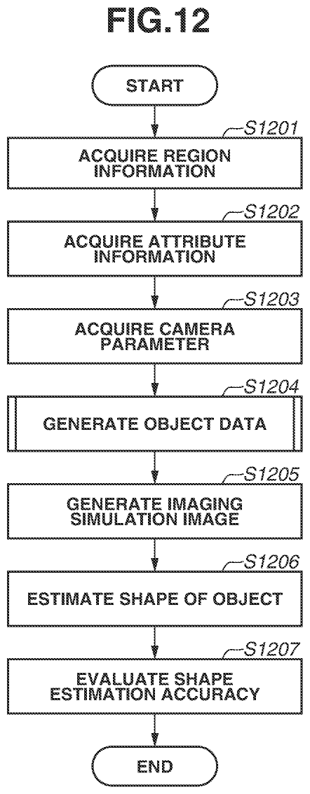

FIG. 12 is a flowchart illustrating an overall flow of processing executed by the information processing apparatus 100 according to the present exemplary embodiment.

In step S1201, the spatial region acquisition unit 201 acquires the region information based on a user instruction. In step S1202, the object attribute acquisition unit 202 acquires the attribute information of the object based on the user instruction.

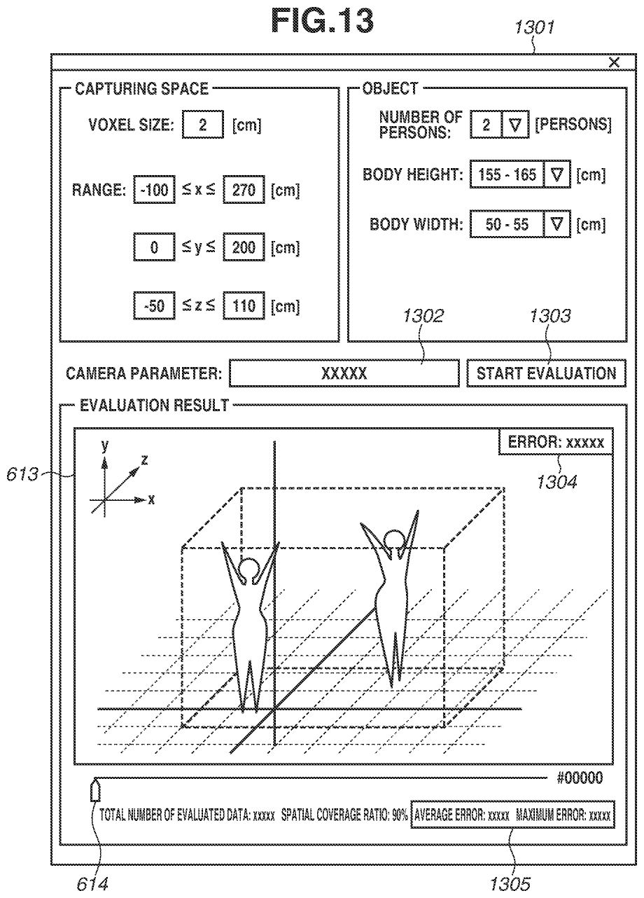

In step S1203, the camera parameter setting unit 1101 acquires a camera parameter file from the external storage device 111 and the like based on the user instruction and sets the camera parameter. The user instruction is received via a GUI 1301 illustrated in FIG. 13. In FIG. 13, a camera parameter setting column 1302 is a column for inputting a path of the camera parameter file. A button 1303 is a button to be pressed (selected) in a case of issuing an instruction to execute evaluation. Display areas 1304 and 1305 are areas for displaying an evaluation result. If the user presses the button 1303, the processing in steps S1201 and S1203 is executed, and then the processing proceeds to step S1204. In the following description, the number of persons of objects acquired in step S1202 is assumed to be M (M is an integer greater than or equal to one) as in the first exemplary embodiment.

In step S1204, the generation unit 203 generates object data based on the region information acquired in step S1201 and the attribute information of the object acquired in step S1202. According to the present exemplary embodiment, the generation unit 203 generates N_{DATA} pieces of object data Data(i) (i=1, 2, . . . , N_{DATA}). The processing in step S1204 is the same as that in step S503 in FIG. 5 according to the first exemplary embodiment, so that the description thereof is omitted.

In step S1205, the rendering unit 1102 renders the object indicated by the N_{DATA} pieces of object data generated in step S1204 (that is, the shape model arranged in the three-dimensional space) to generate an imaging simulation image. The rendering unit 1102 performs rendering using the camera parameter acquired in step S1203. According to the present exemplary embodiment, known computer graphics technology is used for a rendering algorithm of the rendering unit 1102.

If the number of the digital cameras included in the image capturing system is N_{CAM}, the imaging simulation image is generated N_{CAM} pieces for one object data. Hereinbelow, an imaging simulation image in a case where the object indicated by the object data Data(i) is captured by the c-th digital camera included in the image capturing system is represented by Imgᵢ(c) (c=1, 2, . . . , N_{CAM}). The imaging simulation image Imgᵢ(c) is an image obtained by capturing the objects (persons) of M persons arranged according to the object data Data(i).

In step S1206, the shape estimation unit 1103 applies the predetermined shape estimation algorithm to the imaging simulation image Imgᵢ(c) generated in step S1205 for each of the N_{DATA} pieces of object data to acquire estimated shape data EData(i).

In step S1207, the evaluation unit 1104 evaluates accuracy of the estimated shape acquired in step S1206 using the object data generated in step S1204, displays the result on the GUI, and terminates the processing. Specifically, the evaluation unit 1104 calculates a Hausdorff distance d_{H}(i) between the three-dimensional shape indicated by the object data Data(i) and the three-dimensional shape indicated by the estimated shape data EData(i) as an evaluation value for each of i=1, 2, . . . , N_{DATA}. Further, the evaluation unit 1104 calculates an average value and a maximum value of the Hausdorff distance d_{H}(i) and displays these values on the GUI. For example, as illustrated in FIG. 13, an evaluation value calculated from the object data corresponding to an identification number specified by the slider 614 (that is, the object data displayed in the display area 613) is displayed in the display area 1304. In addition, as the evaluation result for the image capturing system, an average value and a maximum value of the evaluation values are displayed in the display area 1305. The evaluation value is not limited to the Hausdorff distance, and may be an index or a value representing difference or similarity between two shapes.

The above-described processing control is performed, and thus, according to the second exemplary embodiment, it is possible to comprehensively evaluate shape estimation accuracy of an assumed object regarding the image capturing system.

Constraints of the image capturing system, such as the number of digital cameras and locations where they can be installed, may be acquired separately, a plurality of camera parameters of the image capturing system satisfying the constraints may be generated, and the above-described evaluation may be performed.

According to a third exemplary embodiment, an example is described in which an object data set in which an object moves at a specified speed is generated in a case where the object data set is regarded as a series of pieces of time-series data representing a movement of the object.

A hardware configuration and a logical configuration of an information processing apparatus 100 according to the present exemplary embodiment are similar to those according to the first exemplary embodiment, so that the descriptions thereof are omitted.

A flowchart illustrating an overall flow of processing executed by the information processing apparatus 100 according to the present exemplary embodiment is substantially the same as the flowchart in FIG. 5 described according to the first exemplary embodiment. Differences in processing according to the present exemplary embodiment are as follows. In step S502, the object attribute acquisition unit 202 acquires a moving speed of the object as the attribute information regarding the object. Further, a content of the object data generation processing by the generation unit 203 in step S503 is different. The processing in steps S501 and S504 is the same as that according to the first exemplary embodiment, so that the description thereof is omitted.

In step S502, the object attribute acquisition unit 202 acquires the number of persons, the body height, the body width, and the moving speed of the objects based on the user instruction via the GUI.

In step S503, the generation unit 203 generates the object data so that the object moves at the moving speed acquired in step S502 based on the region information and the attribute information acquired in steps S501 and S502. As in the case of the first exemplary embodiment, the generation unit 203 continues to generate the object data by changing the arrangement of the object until a union of ratios of the object in the capturing spatial region becomes the predetermined target spatial coverage ratio or more.

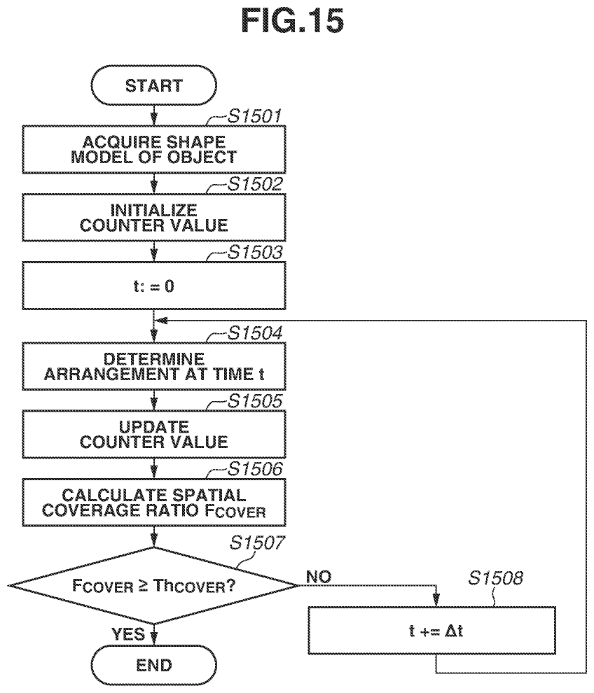

Details of the object data generation processing according to the present exemplary embodiment are described with reference to a flowchart illustrated in FIG. 15. The processing in steps S1501 and S1502 is respectively the same as that in steps S701 and S703 in FIG. 7 according to the first exemplary embodiment, so that the description thereof is omitted. In the following description, the moving speed of the object acquired in step S502 is α [cm/s], and the number of persons of the objects is M (M is an integer greater than or equal to one) as in the case of the first exemplary embodiment.

In step S1503, the generation unit 203 initializes time t to zero.

In step S1504, the generation unit 203 generates object data Data(t) corresponding to the time t.

In a case of the time t=0, the generation unit 203 selects M points from within the capturing spatial region, sets the M points as position coordinates pₘ(0) (m=1, 2, . . . , M) of the objects of M persons at the time t=0, and arranges the shape model acquired in step S1501. At this time, the position coordinates may be selected randomly or, for example, may be selected to be equally spaced on the xz plane. Further, the orientation of the object may be any orientation, may be determined randomly for each individual object person, or may be the same orientation for all of them. Hereinbelow, the position coordinates of the m-th object at the time t are represented by pₘ(t).

In a case of the time t>0, the generation unit 203 randomly selects one point on a circle having a radius r=α *Δt centered at the position coordinates pₘ(t−Δt) for each object person, and arranges the shape model using the selected point as the position coordinates pₘ(t). Here, Δt is a predetermined elapsed time between temporally adjacent object data, for example, Δt= 1/30 [s]. The radius r corresponds to a moving distance (amount of change) in a case where the object moves for time Δt at the speed a. The orientation of the object to be arranged may be any orientation. For example, if the orientation of the object is approximately the same as an orientation indicated by a three-dimensional vector pₘ(t)−pₘ(t−Δt), the object is arranged as if it moves while facing a direction of travel.

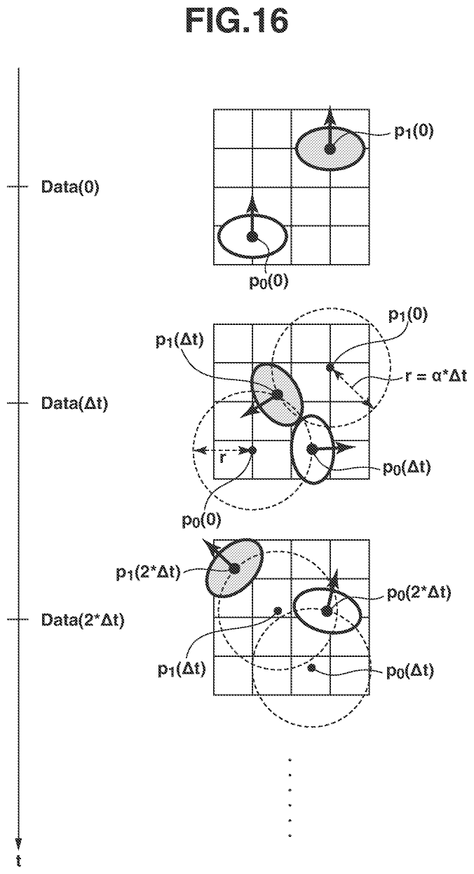

The generation unit 203 stores the shape models for M persons arranged as described above as the object data Data(t) at the time t. FIG. 16 illustrates examples of the object data generated in a case of M=2.

In step S1505, the generation unit 203 calculates the voxel that intersects with the surface in the same way as in step S706 in FIG. 7 for the shape model arranged in step S1504, and increments the counter value by one.

In step S1506, the generation unit 203 calculates the spatial coverage ratio F_{COVER} according to Equation (1) in the first exemplary embodiment.

In step S1507, in a case where the spatial coverage ratio F_{COVER} acquired in step S1506 is the target spatial coverage ratio Th_{COVER} or more (YES in step S1507), the generation unit 203 terminates the object data generation processing. In a case where the spatial coverage ratio F_{COVER} is less than the target spatial coverage ratio Th_{COVER} (NO in step S1507), the generation unit 203 advances the processing to step S1508, adds Δt to the time t, and returns the processing to step S1504.

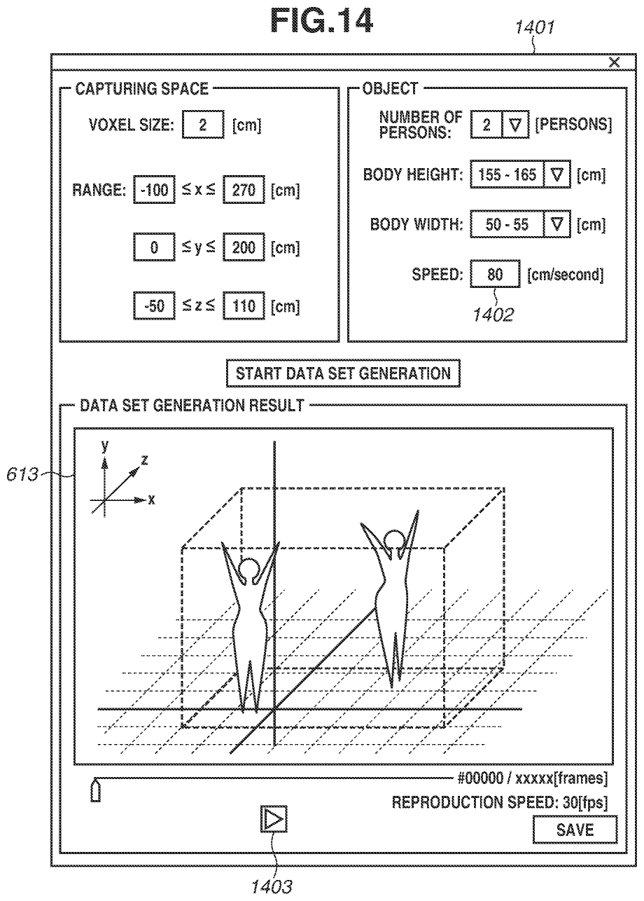

FIG. 14 illustrates an example of a GUI 1401 according to the present exemplary embodiment. In FIG. 14, a speed setting column 1402 is a column for inputting the moving speed of the object. A button 1403 is a button that is pressed in a case where the generated object data set is reproduced as a series of pieces of time-series data. If a user presses the button 1403, the object data displayed on the display area 613 is switched at intervals of Δt [s] as described above.

The above-described processing control is performed, and thus, according to the third exemplary embodiment, an object data set can be acquired for evaluating shape estimation accuracy with respect to a moving object.

According to a fourth exemplary embodiment, an example is described in which object data is rearranged within an object data set according to dispersion of positions of an arranged object for a user to easily use in evaluation.

A hardware configuration and a logical configuration of an information processing apparatus 100 according to the present exemplary embodiment are similar to those according to the first exemplary embodiment, so that the descriptions thereof are omitted.

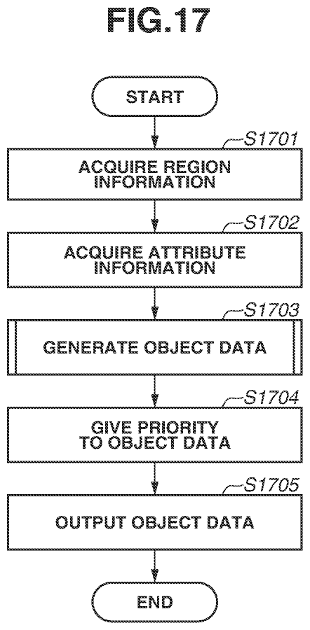

FIG. 17 is a flowchart illustrating an overall flow of processing executed by the information processing apparatus 100 according to the present exemplary embodiment. The processing in steps S1701 to S1703 is respectively the same as that in steps S501 to S503 in FIG. 5 according to the first exemplary embodiment, so that the description thereof is omitted.

In step S1704, the generation unit 203 gives priority to N_{DATA} pieces of the object data Data(i) (i=1, 2, . . . , N_{DATA}) generated in step S1703. According to the present exemplary embodiment, the generation unit 203 sequentially calculates the object data Data(i′) that maximizes dispersion σ²(i′) of the positions of the object calculated by the following equations from the object data to which priority is not given, from n=1 to n=N_{DATA}, and gives priority n-th to the object data Data(i′).

$${σ}^{2} ( {i}^{′} ) = \frac{{\sum }_{i {∈}_{order}} {s}_{Δ} ( i , {i}^{′} ) + {s}_{Δ} ( {i}^{′} , {i}^{′} )}{M * n} \qquad Equation ( 2 )$$

$${S}_{Δ} ( i , {i}^{′} ) = {\sum }_{m = 1}^{M} ( {( {o}_{x} ( i , m ) - {μ}_{x} ( {i}^{′} ) )}^{2} + {( {o}_{y} ( i , m ) - {μ}_{y} ( {i}^{′} ) )}^{2} + {( {o}_{z} ( i , m ) - {μ}_{z} ( {i}^{′} ) )}^{2} )$$

$$μ ( {i}^{′} ) = ( \begin{matrix}{μ}_{x} ( {i}^{′} ) \\ {μ}_{y} ( {i}^{′} ) \\ {μ}_{z} ( {i}^{′} )\end{matrix} ) = \frac{{\sum }_{i {∈}_{order}} {\sum }_{m = 1}^{M} o ( i , m ) + {\sum }_{m = 1}^{M} o ( {i}^{′} , m )}{M * n}$$

$$o ( i , m ) = ( \begin{matrix}{o}_{x} ( i , m ) \\ {o}_{y} ( i , m ) \\ {o}_{z} ( i , m )\end{matrix} )$$

In the above equations, I_{order} is a set of n−1 indices indicating the object data with priority given, and o(i, m) is the position coordinates of the m-th object person included in the object data Data(i). At this time, the object data that maximizes the dispersion of the position coordinates of the object person in a case where it is combined with the n−1 pieces of the object data with the higher priority is selected as the object data with the n-th priority.

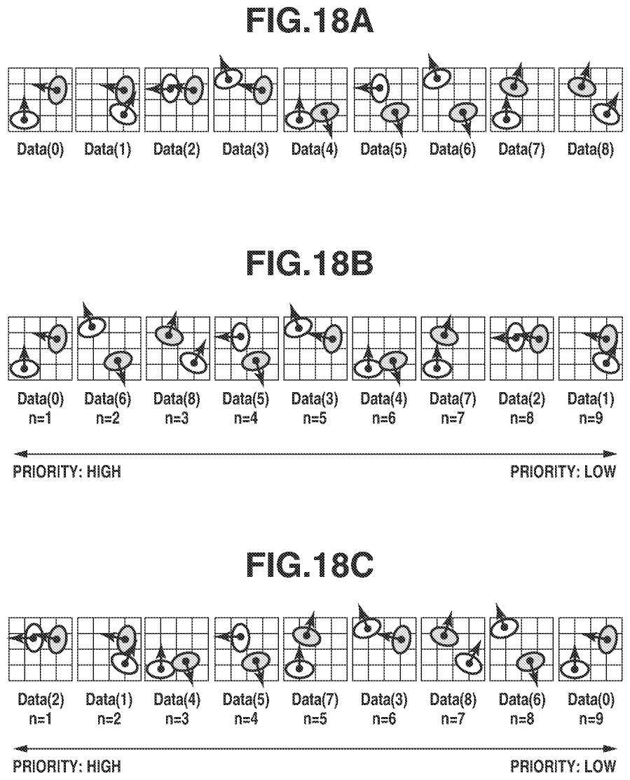

In step S1705, the generation unit 203 stores the object data rearranged according to the priority given in step S1704 as the object data set in the external storage device 111 or the like, and terminates the processing. FIG. 18A illustrates an example of a data set before rearrangement, and FIG. 18B illustrates an example of a data set after rearrangement. In FIG. 18B, the object data are arranged from left to right in descending order of priority. If the processing in steps S1205 to S1207 described in the second exemplary embodiment is applied in order from the object data with the higher priority, it is possible to postpone evaluation of the objects with similar arrangements. In addition, it is possible to comprehend rough shape estimation accuracy regarding the image capturing system without completing the evaluation for all object data.

The above-described processing control is performed, and thus, according to the fourth exemplary embodiment, it is possible to acquire an object data set in which object data are arranged in order according to dispersion of positions of an object.

Object data may be rearranged in ascending order of dispersion of positions of an object included in the object data. In this case, as illustrated in FIG. 18C, higher priority is given to object data with higher density of object persons (that is, higher difficulty of shape estimation).

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-093795, which was filed on Jun. 9, 2022 and which is hereby incorporated by reference herein in its entirety.

What is claimed is:

1. An information processing apparatus comprising:
one or more memories storing instructions; and
one or more processors, wherein the one or more processors execute the instructions to:
acquire region information representing a spatial region in a three-dimensional space;
acquire attribute information regarding an object; and
generate a plurality of pieces of object data representing a shape and an arrangement of the object based on the acquired region information and the acquired attribute information,
wherein, in the plurality of pieces of object data, a union of ratios of a shape model corresponding to the object is a predetermined ratio or more in a region corresponding to the spatial region.

2. The information processing apparatus according to claim 1, wherein the region information includes information indicating a range of the three-dimensional space and information indicating a size of a voxel, which is a unit volume element forming a region corresponding to the three-dimensional space.

3. The information processing apparatus according to claim 2, wherein the one or more processors further execute the instructions to calculate a ratio of the object in the spatial region based on a number of voxels included within the shape of the object.

4. The information processing apparatus according to claim 2, wherein the one or more processors further execute the instructions to calculate a ratio of the object in the spatial region based on a number of voxels intersecting with a surface of the shape of the object.

5. The information processing apparatus according to claim 1, wherein the object is a person, and the attribute information includes at least information about a number of persons, a body height, and a body width.

6. The information processing apparatus according to claim 1, wherein the one or more processors further execute the instructions to:
acquire shape data representing the shape of the object based on the attribute information; and
determine a plurality of patterns of arrangements of the object based on the region information and the shape data.

7. The information processing apparatus according to claim 1, wherein the one or more processors further execute the instructions to give priority to the object data based on dispersion of positions of arranged objects.

8. The information processing apparatus according to claim 1, wherein the one or more processors further execute the instructions to:
acquire a moving speed of the object; and
generate the object data so that the object data is associated with time, and an amount of change in a position of the object between the object data, which are temporally adjacent, is approximately the same as an amount of change according to the moving speed and an elapsed time in the object data.

9. The information processing apparatus according to claim 1,
wherein the one or more processors further execute the instructions to:
set a camera parameter to be used to capture an image of an object arranged in the spatial region;
generate an imaging simulation image using the object data and the camera parameter;
estimate a three-dimensional shape of the object using the imaging simulation image, and
evaluate shape estimation accuracy based on a shape indicated by the object data and an estimated shape estimated by the estimation.

10. A method for processing information, the method comprising:
acquiring region information representing a spatial region in a three-dimensional space;
acquiring attribute information regarding an object; and
generating a plurality of pieces of object data representing a shape and an arrangement of the object based on the acquired region information and the acquired attribute information,
wherein, in the plurality of pieces of object data, a union of ratios of a shape model corresponding to the object is a predetermined ratio or more in a region corresponding to the spatial region.

11. A non-transitory storage medium storing computer-executable instructions for causing a computer to execute a method for processing information, the method comprising:
acquiring region information representing a spatial region in a three-dimensional space;
acquiring attribute information regarding an object; and
generating a plurality of pieces of object data representing a shape and an arrangement of the object based on the acquired region information and the acquired attribute information,
wherein, in the plurality of pieces of object data, a union of ratios of a shape model corresponding to the object is a predetermined ratio or more in a region corresponding to the spatial region.
